(19) United States
(12) Patent Application Publication
(10) Pub. No.: US 2011/0226920 A1
(43) Pub. Date: Sep. 22, 2011

(54) Keyboard adjustment apparatus and associated method

(76) Inventor: Zechariah Ben Moses, Kansas City, KS (US)

(21) Appl. No.: 12/661,385

(22) Filed: Mar. 16, 2010

(51) Int. Cl. F16M 13/00

(52) U.S. Cl. 248/346.01

(57) ABSTRACT

The computer keyboard adjustment apparatus has a support plate that receives a computer keyboard thereon. The support plate, screw dome/wheel and the magnet lock are attached to each other. The magnet lock is anchored to the base. A lock lever is also provided for adjustably, locking the support plate at any desired angle/position. The support plate at this point is operating on an axis moving within the circumference of the axis design. Manipulation of the lever-lock allows the support plate to move forward, backward, and side-to-side. The support plate, once elevated, can tilt or incline as well as decline.

### BACKGROUND OF THE INVENTION

1. Technical Field

This present invention relates to computer keyboard support apparatuses and, in particular to an ergonomic computer keyboard support apparatus that is designed to be used by a person using a personal computer keyboard device to alleviate the tension and stress damage that occurs in the hands, finger and wrist joints, forearms and upper shoulder, caused by typing or keying.

2. Prior Art

To work is to TYPE. In our society it would be difficult to conduct any manner of business without the means to key in and store data via a computer keyboard to keep record of transactions, documents, and such said matters. When the computer keyboard was first introduced, it was fitted with two back legs to elevate the keyboard off the surface into a more ergonomic position, a method still used today. Later, the wrist rest came into existence. The attempt was to elevate the wrist into a more ergonomic position by focusing on the focal point of elevation. These attempts focused on elevation to produce ergonomics. The overwhelming reports of carpal tunnel and other repetitive strain injures has cost millions in doctor bills and lost wages. Companies have felt this impact in lost time, which have lead to productions deficiency. This has led to hundreds of millions in lost revenue.

People deserve the ability to type without falling victim to a typing disease. The present inventive computer keyboard adjustment apparatus is design to remedy this issue. From the beginning of the modern personal computer, increasing reports of repetitive strain injuries such as carpal tunnel has evolved. In the days of the traditional typewriter, these types of injuries were rarely an issue. Do to the original design and structure of the keys, it allowed for a more comfortable feel as opposed to the modern computer keyboard, which sits flat on the table/surface making it difficult to type over extended time periods. For example, the user must bend their wrist almost 90 degrees backwards, while repeatedly striking the keys with their fingers. This causes strain in the hands, wrist, and up the forearms. Accordingly, a need remains for a keyboard adjustment apparatus to overcome the above-noted shortcomings. The present invention satisfies such a need by providing a keyboard adjustment apparatus that is convenient and easy to use, lightweight yet durable in design, versatile in its applications, and designed for elevating the keyboard and alleviating the tension and stress damage that occur in the hands, finger and wrist joints as well as forearm and shoulder

### SUMMARY OF THE INVENTION

The present inventive apparatus with its indicative design is set to remedy repetitive strain injuries such as carpal tunnel, which is a disease that is infamous among common computer keyboard users. The general concept of the computer keyboard adjustment apparatus employs elevation-ergonomics. With this concept, the keyboard adjustment apparatus provides a superior service of approval. The present invention is an ergonomic support apparatus that a user utilizes when working at a personal computer, specifically, the computer keyboard. It is designed to protect against and avoid strain that occurs in the arms, wrists, hands, and fingers during extensive keyboard typing. The present invention supports the computer keyboard on top of a support surface. While having the computer keyboard secured on the support surface, the user can adjust the keyboard in a multitude of motions and or directions.
These motions include up and down, back and forward, side-to-side, as well as incline and decline movement.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

The figures generally include various perspective views showing a keyboard adjustment apparatus, in accordance with the present invention

### DETAILED DESCRIPTION OF THE INVENTION

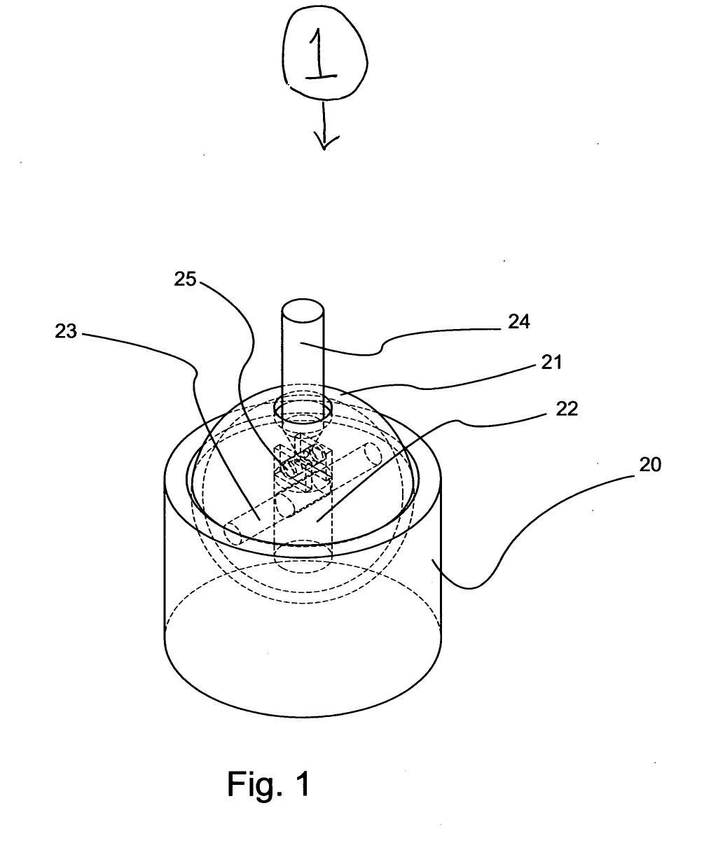

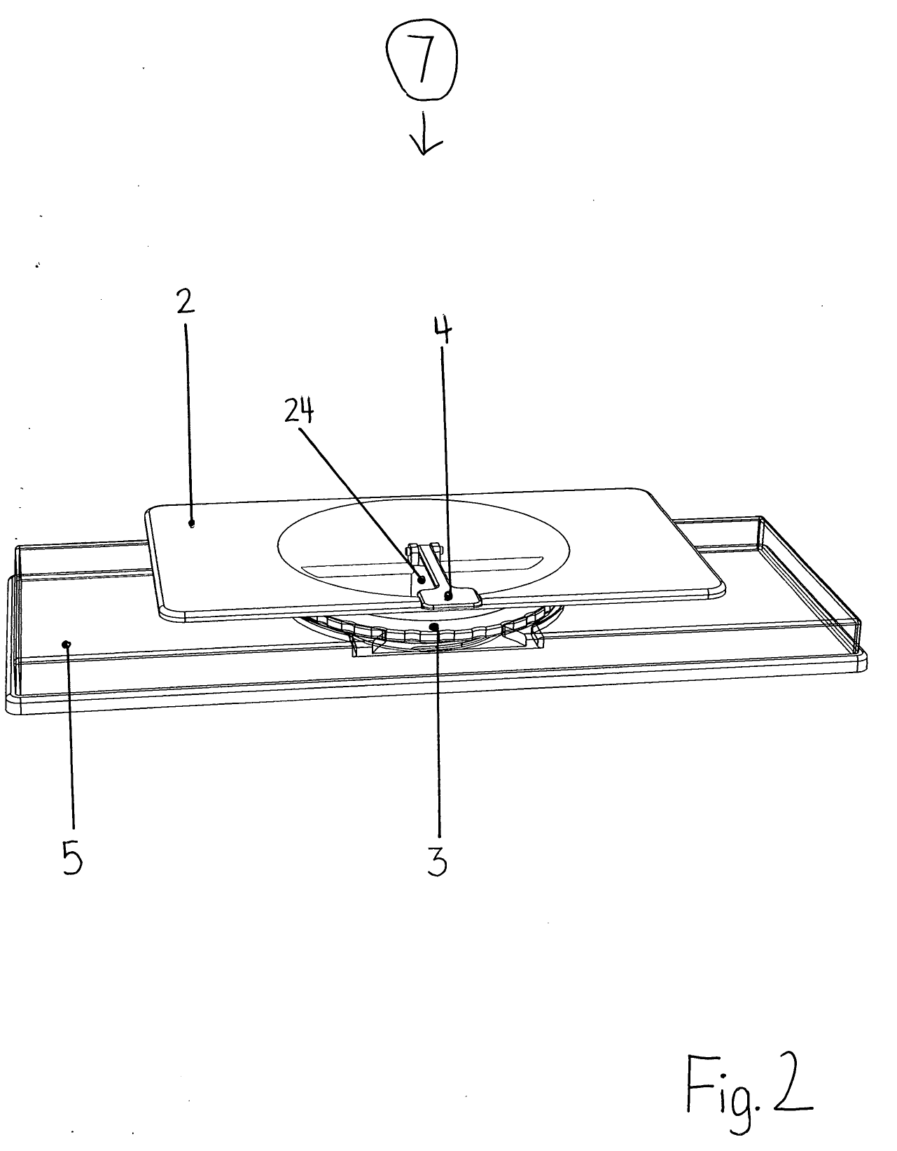

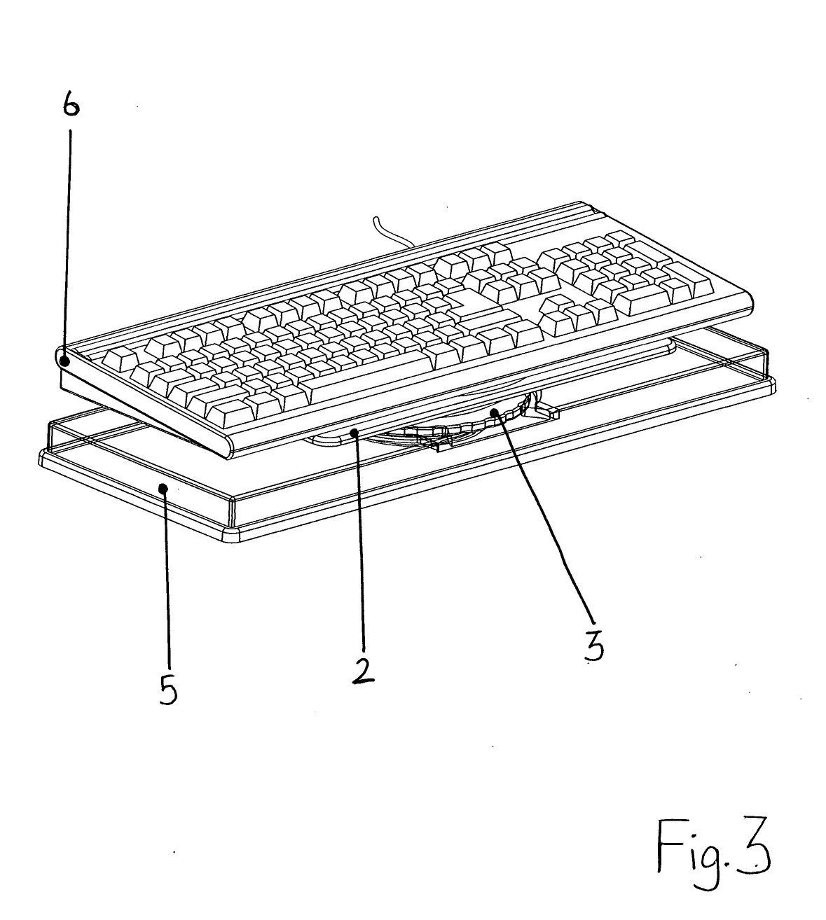

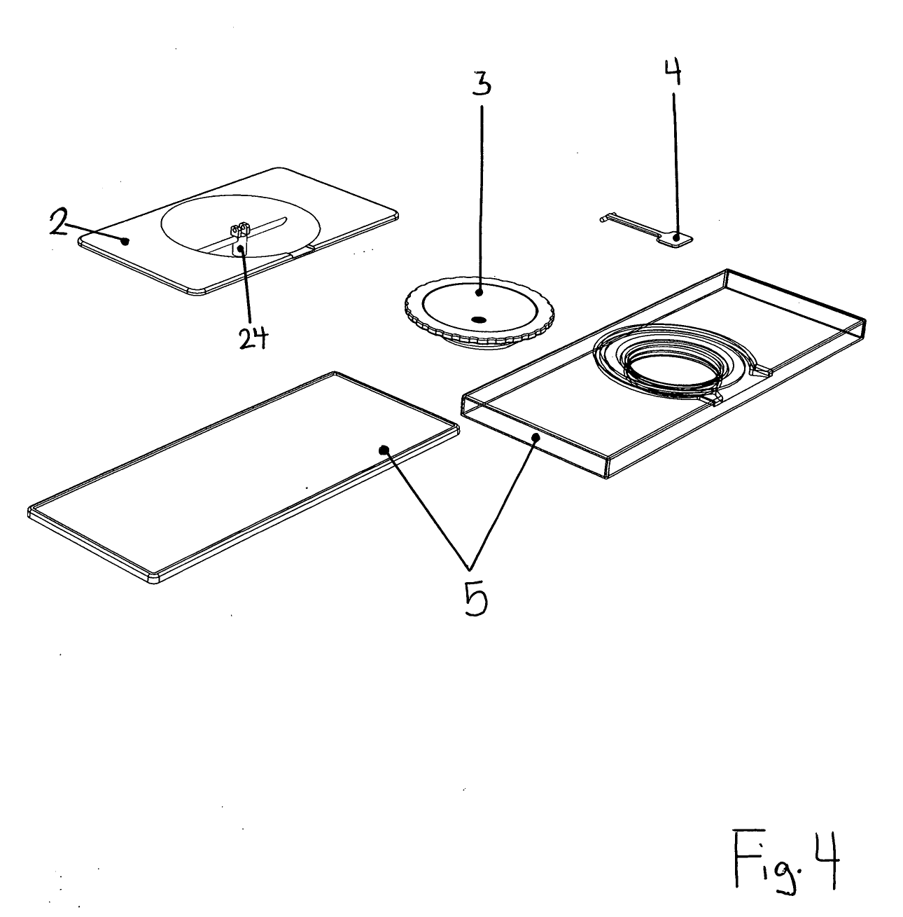

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. The present invention is referred to generally in the figures and is intended to provide a keyboard adjustment apparatus. It should be understood that the present invention may be used for elevating the keyboard and alleviating the tension and stress damage that occur in the hands, finger and wrist joints as well as forearm and shoulder injuries that are caused by prolonged typing or keying, as well as prevent future cases of RSI, corporal tunnel and other related injuries from occurring and should not be limited to the uses described herein. Referring to the FIGS. 1-4) in general, keyboard adjustment apparatus 7 preferably includes the following components: support plate 2, for supporting the keyboard thereon; and screw dome 3 mated to the support plate 2 to allow movement.

The screw dome 3 lowers and raises the keyboard. Magnet lock 1 is mounted inside the bottom base 5 and provides an axis for the apparatus to move. Lock lever 4 is mounted inside the surfboard 2 to lock the position of the keyboard in place. The lock lever 4 will be secure, because the screw dome 3 is made from metal—magnetized injection molding. Top base (2 pieces) 5 houses the female threads to the screw dome 3. The selected material for the keyboard adjustment apparatus 7 and all components may preferably be polypropylene, a very moldable and injection friendly material, to meet the following requirements: high impact resistance; ergonomic appeal for color ability; and injection mold ability. The support plate 2 may be a floating platform on which the computer keyboard 6 sits on. The surface of the support plate 2 may be made from an elastic rubbery material to reduce slip and movement of the keyboard that is placed on top of it. The screw dome 3, the mate component to the support plate 2 may allow the support plate 2 to move. The screw dome 3 preferably raises and lowers the keyboard 6. This function may come from the male threads on the bottom of the screw dome 2, which match the female threads in the top base (2 piece) 5, allowing the dome 3 to screw in and out of the base 5, hence raising or lowering the support plate 2 and the keyboard. The screw dome 3 may preferably be made using metal with magnetized injection molding. The bottom base (2 piece) 5 undersides may be made from a foam rubber material to provide traction. The magnet lock 1 may be mounted inside of the bottom base (2 piece) 5. The cylinder magnet 24 may be erected through the center of the support plate 2. The magnet lock 1 may preferably function as the axis and allow the support plate 2 to move, lock and move again within the circumference of the axis. The magnet lock 1 is the primordial component, giving this present invention apparatus its functionality. This support plate 2 interlocks with the magnet cylinder 24, which is erected through the center of the support plate 2. The lock lever 4 may preferably secure and release the magnet lock 1.

When the lock lever 4 is pushed in, the magnet lock 1 is locked, securing the keyboard in any particular resting position (on an axis) in respect to the circumference of the magnet lock 1 (axis). When the lever lock 4 is pulled out, it releases the magnet lock 1, allowing the support plate 2 to move freely with in the circumference of the magnet lock 1 (axis).

The computer keyboard is secured on top of the support plate 2. With the computer keyboard on this surface material, the computer keyboard will not slide or move. Now in position, the user can adjust the keyboard (by way of Elevation-Ergonomics) to their desired position. If the height of the keyboard is not desirable, the user can turn the screw wheel 3 and the keyboard will ascend up to the desired height/level. The lever lock 4, once unlocked, allows the support plate 2 to move forward, backward, and side-to-side. The support plate 2, once elevated, can tilt or incline as well as decline. The support plate 2 at this point is operating on an axis moving within the circumference of the axis design. This axis is defined along the magnet lock 1.

In a preferred embodiment, the keyboard adjustment apparatus 7 preferably includes four main components but not limited to: the top support plate connected to the screw dome connected to the base connected to the magnet lock. The support plate 2 receives the keyboard thereon. The screw dome 3 raises and lowers the keyboard; this function will come from the male threads on the bottom of the screw dome 3 matching the female threads in the top base apparatus, allowing the dome to screw in and out of the top base apparatus. The screw dome 3 will be made using metal via magnetized injection molding. This injected metal will allow the magnet to lock in the respective position along the screw dome 3 once the lever 4 apparatus is secured.

The base 5 is made of a top base and a bottom base. The bottom base underside is made from a rubber material to allow traction. The top base will house female threads to mate with the male threads on the screw dome 3. This will allow the screw dome 3 to screw in and out of the top base apparatus.

The magnet lock 1 is the most interactive component of the present invention. The magnet lock 1 will be mounted inside of the base 5 and preferably has a cylinder magnet 24 erected through the center of the support plate 2. The magnet lock 1 defines a linear axis and allows the support plate 2 to move, lock and move again within the circumference thereof. The lever lock 4 interlocks with the cylinder magnet 24 that is erected through the center of the support plate 2. This lever lock 4 secures and releases the magnet lock 1. When the lever lock is pushed in a resting position the magnet lock is locked, securing the keyboard in any particular resting position (on an axis) in respect to the circumference of the magnet 1 (axis). Pulling the lever 4 out, releases the magnet lock 1, allowing the support plate 2 to move freely with in the circumference of the magnet 1 (axis).

The magnet lock 1 is situated at an inverted position and positioned inside a housing tube 20, thereby defining a ball/socket type arrangement. The magnet lock 1 is able to freely rotate within the circumference of the socket. A spherical ball 21 is formed at the bottom of the magnet lock and sits inside the Housing socket 20. Wherein the screw dome 3 will be in the shape of a bowl, to mate with the surfboard 2 and have an opening in the center area for the cylinder 24 to fit. In one embodiment, the lever 4 may have a sledgehammer shape and interlocks with the cylinder magnet 24, which is erected through the center of the support plate 2. A cylinder magnet 24 may have joints atop to interlock with the lever lock 4. The housing tube 20 of the magnet lock is connected to the screw dome 3 and the support plate 2 as well as the base 5, thereby allowing the surfboard 2 to operate on an axis. The present invention may be made from a polypropylene plastic material, which is very friendly in conjunction to the proper construction of the keyboard adjustment apparatus. The computer keyboard 6 preferably sits securely on the support plate 2, which may be made from an elastic rubbery material; this will provide the traction, and allow the keyboard to be secured. Once in position, the user has the ability to turn the screw wheel 3 and raise the keyboard.

The screw wheel 3 descends the keyboard as well. The user can pull the lever lock 4, which will unlock the magnet lock 1. This allows the keyboard to float on an axis, moving within the circumference of the axis: front, back, side-to-side. Pushing the lever lock secures the magnet lock, and the keyboard will lock the same in forward, backward, or right-to-left, this also includes ascension from its genesis. All positioning and adjustments made will lock once the lever lock 4 is secured. The user now has the freedom via elevation-ergonomics to exactly place the keyboard to best fit their personal preference.

Reference will now be made in detail to the preferred embodiments of the present invention, examples of which are illustrated in the accompanying drawing. It is to be understood that the figures and the description of the present invention included herein illustrate and describe elements that are of a particular relationship to the present invention, while eliminating other elements that may be found in other ergonomic devices.

In use, the keyboard adjustment apparatus 7 would be simple and straightforward to use. First, the user would place the keyboard adjustment apparatus 7 in an upright position where the computer keyboard 6 would normally rest, such as on a desk. In this position, the bottom base 5 will reduce slip and movement of the keyboard adjustment apparatus 7. Next: the user would place the keyboard 6 on top of the support plate 2. The elastic rubbery material holds the keyboard in place by reducing slip and movement.

Next, the user would raise or lower the support plate 2, and thus the keyboard 6 by screwing the wheel 3 until the user achieves the desired height. Next, the user would pull out the Lock Lever 4 to allow the support plate 2 to move freely along the axis of the magnet lock 1 until the user has achieved the ideal position of the keyboard 6. Next, the user would push the lock lever 4 in, thus locking the support plate 2 in its position. Next, the user may use the keyboard 6 as desired in a more comfortable position, which reduces the chances of RSI, corporal tunnel and other related injuries.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A computer keyboard adjustment apparatus for elevating a computer keyboard and alleviating the tension and stress damage that occur in the hands, fingers and wrist joints as well as forearm and shoulder while typing or keying.

2. A computer keyboard adjustment apparatus for elevating a computer keyboard and; once elevated able to perform motion and or mobility such as but not limited to forward, backwards, right-to-left, incline and or decline; all functions to produce Elevation-Ergonomics.

3. A magnet lock apparatus such as stated in this said document for its original concept and design to allow functionality for a computer keyboard adjustment apparatus.
